(19) United States
(12) Patent Application Publication
(10) Pub. No.: US 2002/0121109 A1
(43) Pub. Date: Sep. 5, 2002

(54) Glass substrate processing method

(76) Inventor: Kazuo Aita, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/033,873

(22) Filed: Dec. 20, 2001

(30) Foreign Application Priority Data
Dec. 21, 2000 (JP) 2000-389107

(51) Int. Cl. C03C 15/00; C03C 21/00

(52) U.S. Cl. 65/30.13; 65/31

(57) ABSTRACT

With the defect repairing of the present invention, gallium ions are irradiated/injected at a specified position for a glass substrate corresponding to a defect remaining after digging of a trench into a Levenson mask using a focused ion beam apparatus, the glass substrate into which the gallium ions have been injected then being soaked in an alkaline solution so that portions impregnated with gallium ions are removed by dissolving in a localized manner.

### BACKGROUND OF THE INVENTION

The present invention relates to a method for processing a glass substrate using a focused ion beam apparatus, and particularly relates to a method of processing appropriate for correcting defects remaining after digging of a half-wavelength deep trench in a glass substrate for a Levenson mask.

Photolithographic processing limits depend on the wavelength of light used in exposure. A Levenson mask has been proposed as a method of dramatically improving such resolution limits. A Levonson mask is based on the theory of phase shift techniques, and is constructed in such a manner that light passing through transmission holes in the vicinity of the mask is shifted by a phase of a half-wavelength. As a result of the phase of the light being shifted by half a wavelength, in the plane of projection, light on both sides is superimposed so that light interference occurs so as to cause canceling out. The projected image for nearby transmission holes is then projected in a partitioned but lucid manner. A method of digging a trench in a transparent substrate of a mask to a depth of a half-wavelength so as to bring about a half-wavelength difference, and a method of interposing a transparent member (shifter) having a thickness of half a wavelength are well known as methods for inverting phase for these Levenson masks, but the former method is the more prevalent.

A Levenson type phase shift mask is manufactured in the following manner. As shown in the process in FIG. 3, \mathring{1} the surface of a silica glass substrate is covered in a chrome thin film and a material for a resist film is applied in preparation on top. \mathring{2} The desired slit pattern is then exposed and developed. \mathring{3} The substrate is then soaked in a nitric acid second cerium ammonium liquid. When wet etching is then performed, portions of chrome where the chrome surface is exposed through development come into contact with the liquid and are removed by dissolving. The glass substrate therefore becomes exposed at these portions. \mathring{4} Resist remaining on the substrate surface is then removed at this stage and scanning and repairing of the etched pattern is performed. \mathring{5} A resist film is then re-applied to the substrate surface at this stage. This resist used is resistant to dry etching. \mathring{6} There is therefore superimposition of the pattern remaining only at every other slit of the mask pattern at the substrate, with exposure and development then being carried out. As a result, glass substrate becomes exposed for every other slit within the mask pattern. \mathring{7} In this state, when the surface of the substrate is exposed to an ion beam so as to perform dry etching while blowing nitrogen carbon gas, the glass substrate is etched and dug into. \mathring{8} Resist remaining on the surface of the substrate is then removed and the substrate is washed. \mathring{9} Scanning then takes place, pellicles are adhered, and the item is complete.

In the manufacture of the former type of Levenson mask, exposure is necessary two times, with the first exposure being for forming the pattern in \mathring{2} and the second exposure being to perform position alignment in \mathring{6} and to form a trench dug in the substrate to a depth of half a wavelength. However, defects remaining after processing for digging of the trenches occur due to causes such as superimposition shifting etc. It is necessary to correct the mask defects because the mask defects directly influence the quality of the device. However, ion beam milling employing assist gases such as xenon fluoride etc. or mechanical processing employing probes have been tried to correct these defects but as yet, a reliable repairing method has not been found.

In the case of ion beam milling employing an assist gas, the kind of focused ion beam apparatus shown in FIG. 2 are employed. Ions are drawn out from an ion source 1 and are focused and accelerated into a focused ion beam 2 by an ion optical system 3. The beam is then deflected by a deflector 4 and ions are irradiated onto a prescribed position of a sample 9 on a sample stage 7. In processing employing gas-assisted etching where an ion beam is irradiated while blowing gas out from a gas gun 6, a surface of the sample at a specified irradiation region incurs ion collisions and displaced sample material then reacts with the assist gas to bring about volatility. In this process, the sample gas promotes elimination through volatility, and is characterized by processing speed being faster at each stage compared with sputtering etching involving simple physical trimming. However, in the case of this processing, it is difficult to control the etching rate corresponding to the amount of processing in the depth direction, and when ions such as irradiated gallium etc. are introduced, there is a residual ion problem that incurs damage to the transparency of the glass substrate, and the material is sullied as a result of material made to fly off by the etching becoming attached to the surface. Further, methods such as mechanical processing etc. using probes are finely detailed processes and such repairing processing takes time and labor.

### SUMMARY OF THE INVENTION

It is therefore an object of the present invention to provide a processing method for correcting defects remaining after processing of trenches dug into a Levenson mask where troublesome processing control such as controlling etching rate etc. is not required, where there is no problem with residual ions damaging the transparency of the glass substrate and where removed material does not sully the surface, where this processing method can be finished in a clean and precise manner.

The present invention therefore adopts a method whereby gallium ions are irradiated/injected at a specified position for a glass substrate corresponding to a defect remaining after processing for digging a trench into a Levenson mask using a focused ion beam apparatus, the glass substrate into which the gallium ions have been injected then being soaked in an alkaline solution so that portions impregnated with gallium ions are removed by dissolving in a localized manner.

### BRIEF DESCRIPTION OF THE DRAWINGS

FIG. 1 is a view showing a defect remaining after cutting a trench into a Levenson mask.

FIG. 2 is a view illustrating the basic structure of a focused ion beam apparatus used in the present invention.

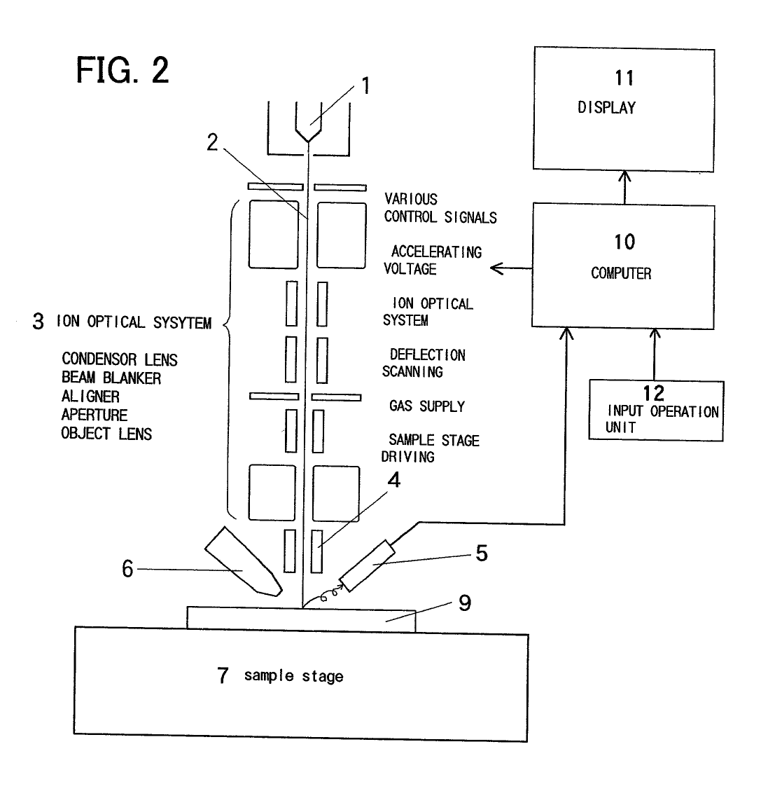

FIG. 3 is a view illustrating a process for manufacturing a Levenson mask.

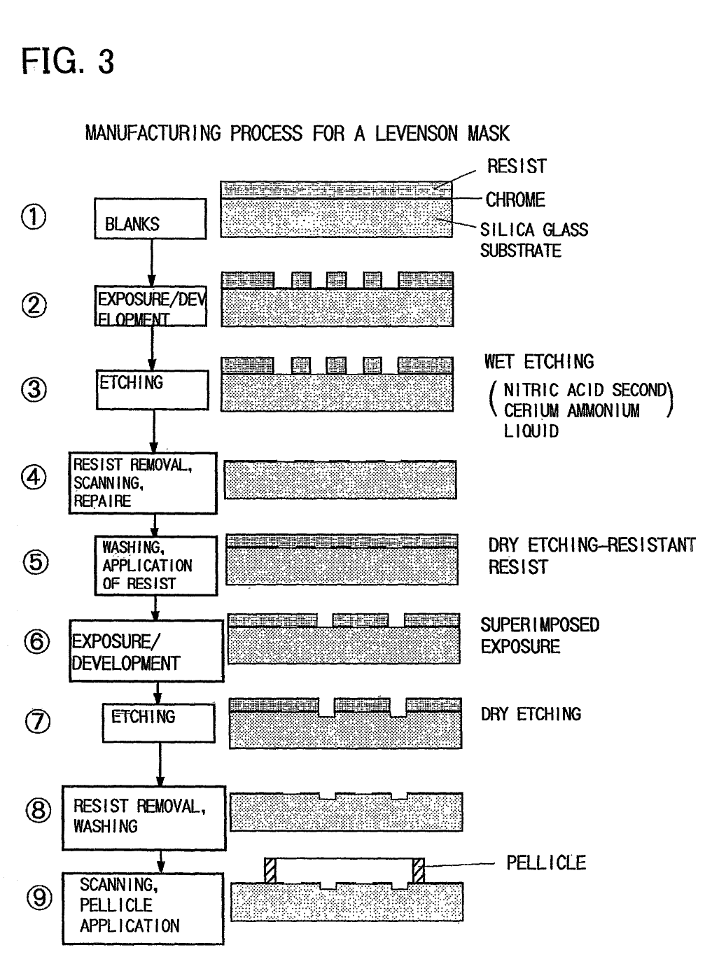

[Description of the Numerals]

| | | | |
|---|---|---|---|
| 1 | ion source | 9 | sample |
| 2 | focused ion beam | B | glass substrate |
| 3 | ion optical system | C | dug trench |
| 4 | deflector | M | defect |
| 5 | secondary charged particle detector | | |
| P | chrome pattern | | |
| 6 | gas gun | | |
| 7 | sample stage | | |

### DETAILED DESCRIPTION OF THE INVENTION

In the present invention, a novel processing method is provided for correcting defects remaining after processing of trenches dug into a Levenson mask, where troublesome processing control such as controlling etching rate etc. that was tried in methods in the related art is not required, where there is no problem with residual ions damaging the transparency of the glass substrate and where removed material does not sully the surface, where this processing method can be finished in a clean and precise manner. However, the present invention takes note of the injection of ions that normally accompanies ion beam processing, and takes into consideration the utilization of this phenomena. This phenomena is generally an inconvenient phenomena and brings about the problem of eliminating residual ion elements. However, in the present invention, gallium ions are selectively injected into the glass substrate by a focused ion beam employing gallium from a metal ion source as ions. Portions of the silica glass that include gallium then come into contact with alkaline solution and are removed by dissolving. In order to correct defects remaining for processing for digging trenches for a Levenson mask, it is necessary to only implement processing with respect to defect portions, i.e. with respect to that remaining after processing for digging trenches. Processing regions in a two-dimensional plane can be used to decide ion injection regions. Compatibility with this can then be easily achieved by specifying an ion beam irradiation region but the processing depth relates to \mathring{1} ion injection depth and \mathring{2} conditions for reacting with alkaline solution. In the case of a Levenson mask, the trench processing depth is aligned with the half-wavelength of the light used as a light source but the target use in this case is extremely important. In the former \mathring{1}, it is possible to control ion injection depth by changing the energy of the ion beam. In the latter \mathring{2}, it is possible to control processing depth by change temperature, concentration and reaction time of the alkaline solution. The depth of ions injected into silica glass at the time of irradiation with an ion beam of an energy of 20 keV is approximately 19 nm. However, removal by dissolving down to approximately 30 nm can be achieved by subsequent treatment of the alkaline solution.

The relationship between ion beam energy and gallium ion injection depth to silica glass is obtained from the following equation by calculation with an energy of 10 keV or more.

y=5.8×x+67

where y is ion injection depth expressed in Angstroms

and x is the ion beam energy value expressed in keV.

Further, an amount (dose amount) of injected ions of at least 1×10¹⁰ ions/cm² is required,

with this typically being 5×10¹⁴ ions/cm².

As described above, with the technological idea of the present invention, injection of gallium ions is carried out, gallium residual within the sample and alkaline solvent are made to react and the region injected with these gallium ions is then removed by dissolving. However, in this gallium ion injection process, sputtering etching is carried out by necessity in the ion beam irradiation. Repairing by removing defects remaining for the processing for digging trenches in the Levenson mask is therefore also performed as part of this process. It is therefore also possible to use sputtering etching together rather than just simply carrying out ion injection in this process as a method of aggressively performing repairing that accompanies this processing by necessity. When the processing depth is deep, it is necessary to increase the energy of the ion beam in order to also make the depth of ion injection deep. However, if the energy is increased, problems such as damage etc. also occur, so there are also cases where it is not wished to increase the energy. At such times, methods are adopted where processing is implemented in advance using etching while allowing an ion injection depth corresponding to the set energy state to remain. Therefore, even if material that flies off in the etching process becomes affixed to the sample surface so as to sully it, this is washed off in the subsequent process of soaking in an alkaline solution and does not present a problem. Etching employing an assist gas is utilized in order to speed up this process but as described above, it is difficult to control the etching rate with this method, and this process is therefore inappropriate.

With the processing method of the present invention described above, a description is given of the case of taking a defect remaining after digging of a trench portion of a Levenson mask as a target. The present invention is, however, by no means limited in this respect and it may easily be understood that the present invention may broadly be applied as a method for precision processing glass material. This is based on injecting gallium ions into the glass material and then removing the glass material by dissolving using a reaction between the injected portion and the alkaline solution. For example, broad application is possible from processing of various glass substrates to fine processing for crafting glass.

[First Embodiment]

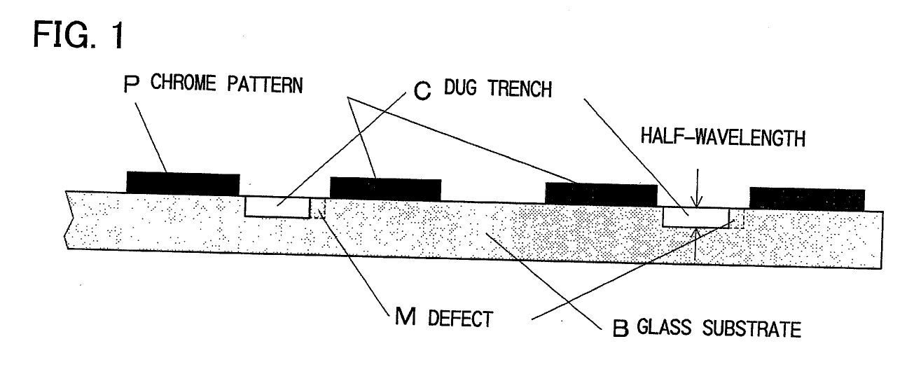

Next, a specific example embodying the present invention is introduced. A defect exists at a trench C dug as shown by M in FIG. 1 at a manufactured Levenson mask. The trenches C are provided at intervals of every other one between the chrome pattern P. With this design, portions shown by a broken line have to be dug but glass still remains at these portions. Assuming that far ultraviolet light of wavelength 193 nm is used as the light source, the trench depth is then the half-wavelength in silica glass of refractive index 1.45, i.e. digging processing is carried out to a depth of approximately 67 nm. This region is then irradiated with a focused ion beam of gallium and the energy of the ion beam for injecting ions to this depth, from the equation in the aforementioned relationship, is 104 keV. However, in this example, the energy of the ion beam is kept down to 20 keV in order to avoid damaging the sample. In doing so, the depth of gallium injection into the glass substrate B is 19 nm. Digging processing to 48 nm from the surface is then carried out by gas-assisted etching and the remaining gallium injected to a depth of 19 nm is then removed by dissolving by treating with alkaline solution.

In this example, the dose amount cannot be regulated as a result of the processing for digging down to 48 nm being carried out by gas assisted etching. The process of removal by dissolving is therefore regulated thereafter using the alkaline solution conditions. In this embodiment, soaking takes place with a base of concentration 1 for ten minutes in a sodium hydroxide solution at a temperature of 50 degrees centigrade, and dissolving treatment is performed. Repairing processing is then performed to achieve matching with already processed trenches. In this embodiment, the energy of the ion beam is kept down to 20 keV and the processing for digging down to 48 nm is performed using conventional methods. Gallium injected to a depth of 19 nm is then removed by dissolving in alkaline solution and final repair is performed. Troublesome control required in the processing is therefore no longer necessary, residual ion problems no longer exist, problems with material that flies off becoming stuck about the periphery are eliminated, and a precise, clean finish can be given to the processing surface.

In the present invention, a method of processing a glass substrate comprises a step of irradiating/injecting gallium ions into a region of a glass substrate to be processed using a focused ion beam apparatus, and a step of soaking the glass substrate in an alkaline solution so that portions impregnated with gallium ions are removed by dissolving in a localized manner. The processing depth can then be regulated by changing either the focused ion beam energy or the substrate erosion time. This overcomes problems encountered in the related art such as problems with troublesome control of etching rate in focused ion beam milling employing an assist gas tried in the related art and problems with residual ions, enables accurate processing where troublesome fine processing such as mechanical processing employing probes is no longer necessary, and means that problems with material flying off during processing becoming adhered to the surface of the sample no longer occur.

Further, in the present invention, if irradiation time is set every dot based on the dose amount, the gallium injection amount can be made uniform. If the relationship between the ion beam energy and the ion injection depth and the relationship between the gallium dose within the glass substrate, the temperature, concentration and reaction time of the alkaline solution used, and the dissolving depth are understood in advance by experimentation, stable and reliable defect repairing can then be performed in a straightforward manner.

1. A method of processing a glass substrate comprising the steps of: injecting gallium ions into a region of a glass substrate to be processed using a focused ion beam apparatus; and soaking the glass substrate in an alkaline solution so that portions impregnated with gallium ions are removed by dissolving in a localized manner.

2. The method of processing a glass substrate of claim 1, wherein processing depth is regulated by changing either of focused ion beam energy or substrate erosion time.

3. The method of processing a glass substrate of claim 1, wherein etching rate is regulated by changing either of the temperature or concentration of the alkaline solution.

4. The method of processing a glass substrate of claim 2, wherein etching rate is regulated by changing either of the temperature or concentration of the alkaline solution.

5. A method of processing a glass substrate comprising the steps of: irradiating gallium ions into a region of a glass substrate to be processed using a focused ion beam apparatus, performing dry etching and performing ion injection; and soaking the glass substrate in an alkaline solution so that portions impregnated with gallium ions are removed by dissolving in a localized manner.

6. The method of processing a glass substrate of claim 1, wherein the glass substrate is a Levenson mask substrate, and the portion to be processed is a half-wavelength-deep defect remaining after digging of a trench.

7. The method of processing a glass substrate of claim 5, wherein the glass substrate is a Levenson mask substrate, and the portion to be processed is a half-wavelength-deep defect remaining after digging of a trench.
